(19) United States
(12) Patent Application Publication
(10) Pub. No.: US 2019/0193268 A1
(43) Pub. Date: Jun. 27, 2019

(54) ROBOTIC ARM PROCESSING SYSTEM AND METHOD, AND NON-TRANSITORY COMPUTER-READABLE STORAGE MEDIUM THEREFOR

(71) Applicant: UTECHZONE CO., LTD., New Taipei City (TW)

(72) Inventor: Chia-Chun TSOU, New Taipei City (TW)

(21) Appl. No.: 15/962,875

(22) Filed: Apr. 25, 2018

(30) Foreign Application Priority Data
Dec. 25, 2017 (TW) 106145567

(51) Int. Cl. B25J 9/16

(52) U.S. Cl. CPC B25J 9/1666; B25J 9/1697; Y10S 901/47; Y10S 901/09; B25J 9/1605

(57) ABSTRACT

The present invention is to provide a robotic arm processing system, comprising: at least one robotic arm, at least one three-dimensional (3D) environment scanning device, and a processing device coupled between the robotic arm and the 3D environment scanning device. The robotic arm performs a processing procedure on at least one workpiece in a working area. The three-dimensional (3D) environment scanning device scans the working area to obtain 3D environment information of the working area. The processing device configures for generating a 3D model of the workpiece and a 3D model of the working area according to 3D environment information of the workpiece and the 3D environment information of the working area. Wherein the processing device generates a working path according to the 3D model of the workpiece and the 3D model of the working area and drives the robotic arm along the working path to perform a corresponding working procedure on the workpiece.

### BACKGROUND OF THE INVENTION

### 1. Technical Field

The present invention relates to a robotic arm processing system and more particularly to one configured for performing three-dimensional (3D) modeling on its working environment in order to find the optimal working path by analyzing the 3D models obtained.

### 2. Description of Related Art

With the advent of full automation, Germany pioneered the concept of Industry 4.0, whose focus is placed not on inventing new industrial technologies as are those of previous industrial objectives, but on incorporating the existing industry-related technologies, sales operations, and product experiences into a smart factory that features adaptivity, resource efficiency, and ergonomics, and on integrating clients with business partners in commercial processes and value streams in order to provide satisfactory after-sales services.

The technical foundation of Industry 4.0 lies in smart integrated sensing and control systems and the Internet of things. While the main structure of Industry 4.0 is still under development, a new smart industrial world with awareness in sensing can be expected when the concept is finally realized and put to practical use. The goal is to derive customized solutions (i.e., those intended to completely satisfy clients' needs) directly from an analysis of the big data collected from the market.

In high-precision industrial processes where exactitude and reliability of assembly are emphasized, multi-axis robotic arms are generally used in place of manual labor as the means of manufacture. In Industry 4.0, multi-axis robotic arms also play an important role in smart machine technologies mainly because of their programmability and teaching-playback function, which make such robotic arms more flexible in use than other equipment and therefore more capable of meeting the complicated requirements of industrial processes. In an Industry 4.0-based manufacturing process, however, a multi-axis robotic arm that can only be programmed for operation is not flexible enough to deal with the customization requirements of Industry 4.0.

### BRIEF SUMMARY OF THE INVENTION

The primary objective of the present invention is to provide a multi-axis robotic arm with a self-adaptive learning function so that the robotic arm can find the optimal working paths in non-single manufacturing processes required by product customization.

To achieve the foresaid objective, the present invention provides a robotic arm processing system, comprising: at least one robotic arm, at least one three-dimensional (3D) environment scanning device, and a processing device. The robotic arm performs a processing procedure on at least one workpiece in a working area. The three-dimensional (3D) environment scanning device scans the working area to obtain 3D environment information of the working area. The processing device coupled between the robotic arm and the 3D environment scanning device configures for generating a 3D model of the workpiece and a 3D model of the working area according to 3D environment information of the workpiece and the 3D environment information of the working area. The processing device generates a working path according to the 3D model of the workpiece and the 3D model of the working area and drives the robotic arm along the working path to perform a corresponding working procedure on the workpiece.

Further, the processing device comprises: a 3D modeling module for generating the 3D model of the workpiece and the 3D model of the working area according to the 3D environment information of the workpiece and the 3D environment information of the working area; a workpiece identification module for identifying the workpiece and obtaining the corresponding processing procedure of the workpiece; and a path planning module for planning an optimal working path through excluding interference-prone areas between the robotic arm and the working area.

Further, skeletal parameters and coordinates of the robotic arm are stored in a storage unit in advance, and the processing device obtains a plurality of axial parameters of the robotic arm in real time in order to generate a 3D model of the robotic arm according to the skeletal parameters and the coordinates of the robotic arm.

Further, before the workpiece enters the working area, a 3D object scanning device generates the 3D model of the workpiece by scanning the workpiece and transmits the 3D model of the workpiece to the processing device; wherein the processing device locates the workpiece on a global coordinate system through at least one sensor.

Further, after identifying a plurality of codes of the workpiece, the processing device obtains a corresponding assembly procedure in a lookup table according to the plurality of codes and plans the optimal working path according to the assembly procedure.

Further, the code of the workpiece is obtained through a barcode reader provided on one side of a carrying device.

Further, the code of the workpiece is obtained by the processing device comparing the 3D model of the workpiece against a category in a database.

Another objective of the present invention is to provide a robotic arm processing method, comprising the steps of: scanning a working area of a robotic arm in order to obtain three-dimensional (3D) environment information of the working area; generating a 3D model of a workpiece and a 3D model of the working area according to 3D environment information of the workpiece and the 3D environment information of the working area; and generating a working path according to the 3D model of the workpiece and the 3D model of the working area, and driving the robotic arm along the working path to perform a corresponding processing procedure on the workpiece.

Further, the robotic arm processing method further comprising the steps of: identifying the workpiece through a code of the workpiece; obtaining a corresponding assembly procedure in a lookup table according to the codes obtained and planning the working path according to the corresponding assembly procedure.

Further, before the workpiece enters the working area, scanning the workpiece in order to generate the 3D model of the workpiece and locates the workpiece in a global coordinate system.

Another objective of the present invention is to provide a non-transitory computer-readable storage medium comprising a computer program to be accessed by a device in order to perform the robotic arm processing method.

Thus, the present invention has the following beneficial effects compared with the prior art:

1. The present invention renders a robotic arm self-adaptive and thereby enables the robotic arm to find the optimal working paths in non-single manufacturing processes of customized products.

2. The invention can be used in a non-normal working environment, allowing a relatively good working path to be obtained by detecting changes in the working environment in real time and replanning the working path according to the changed working environment.

### BRIEF DESCRIPTION OF THE SEVERAL VIEWS OF THE DRAWINGS

FIG. 1 is a front view of a robotic arm processing system of the present invention.

FIG. 2 is a perspective view of the robotic arm processing system of the present invention.

FIG. 3 is a block diagram of the robotic arm processing system of the present invention.

FIG. 4 shows a state of use of the robotic arm processing system in a first application example of the present invention.

FIG. 5 shows a state of use of the robotic arm processing system in a second application example of the present invention.

FIG. 6 shows a state of use of the robotic arm processing system in a third application example of the present invention.

FIG. 7 shows a state of use of the robotic arm processing system in a fourth application example of the present invention.

FIG. 8 is the flowchart of a robotic arm processing method according to the present invention.

### DETAILED DESCRIPTION OF THE INVENTION

The details and technical solution of the present invention are hereunder described with reference to accompanying drawings. For illustrative sake, the accompanying drawings are not drawn to scale. The accompanying drawings and the scale thereof are not restrictive of the present invention.

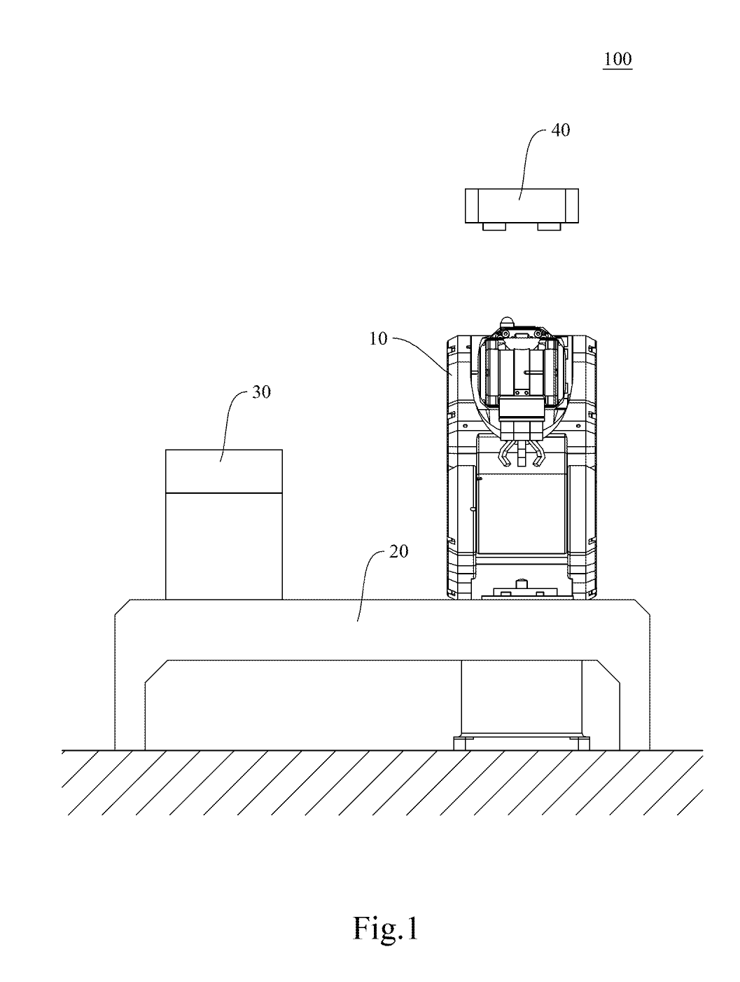

Please refer to FIG. 1 to FIG. 3 respectively for a front view, a perspective view, and a block diagram of a robotic arm processing system according to the present invention.

The present invention provides a robotic arm processing system 100 suitable for use in mass production. The robotic arm 10 in the system is self-adaptive to the working environment (which can be a complicated one) in order to find the optimal working path and perform the corresponding assembly process. The robotic arm processing system 100 essentially includes the robotic arm 10, a carrying device 20, a 3D object scanning device 30, a 3D environment scanning device 40, a processing device 50, and a storage unit 60, as described in detail below with reference to a preferred embodiment.

The robotic arm 10 is configured to perform a processing procedure on at least one workpiece in the working area. The robotic arm 10 may be an articulated multi-axis robotic arm with multiple joints and a servomotor that enables linear, two-dimensional, or 3D movement of the arm in order for the arm to perform the intended work. Structurally speaking, the robotic arm 10 is composed of a robotic arm body, a controller, a servomechanism, and sensors. A program is used to set predetermined operations of the robotic arm 10 according to operation requirements. Data of the joints can be transformed into Cartesian, cylindrical, polar, or other types of coordinates in order to determine the representative positions (e.g., X-, Y-, and Z-axis coordinates) of the robotic arm 10 in a 3D space, and for the robotic arm 10 to work or move within the length limit of each coordinate axis.

The carrying device 20 may be a linear platform, a conveyor belt, or an X-Y table, for example, and is configured to transport a workpiece WP along a fixed route to the working area. In one preferred embodiment, the carrying device 20 is provided with sensors or with reference points identifiable by a camera so that the position of the workpiece WP in relation to the carrying device 20 can be determined with ease, allowing the robotic arm 10 to obtain the correct coordinates of, and thereby pinpoint, the workpiece WP once the workpiece WP enters the working area. In another preferred embodiment, a plurality of workpieces WP are placed on a storage platform with a plurality of placing areas or more specifically are each placed at a fixed position on the storage platform so that all the workpieces WP can be rapidly located when the storage platform is in the working area. The latter embodiment is especially suitable where a conveyor belt is used as the carrying device 20.

The 3D object scanning device 30 may be a 3D scanner configured for obtaining the appearance parameters of the workpiece WP and sending the parameters to the processing device 50 in order for the processing device 50 to analyze the parameters and thereby generate a 3D model of the workpiece WP. Such a 3D scanner may be of the contact type or the non-contact type. A contact-type 3D scanner, such as a coordinate measuring machine, plans depth by actually touching the surface of an object. A non-contact 3D scanner can be categorized as active or passive. Active scanning is carried out by projecting energy to an object and planning 3D spatial information based on the reflected energy and is used in such distance measuring methods as the time-of-flight method, the triangulation method, the structured-lighting method, and the modulated-lighting method. Passive scanning, on the other hand, involves measuring the visible light reflected from the surface of the object being scanned in order to create a 3D model of the object. Examples of passive scanning methods include the stereoscopic method, the shape-from-shading method, the photometric stereo method, and the contour method.

The 3D environment scanning device 40 is configured to scan the working area and thereby obtain 3D environment information of the working area. More specifically, the 3D environment scanning device 40 may be an active depth camera, a binocular camera, a 3D scanner, or a combination of cameras for taking images to be subsequently processed by the processing device 50 in order to generate a 3D model; the present invention has no limitation in this regard. Preferably, the range over which the 3D environment scanning device 40 can take images covers the main working area. This enables the 3D environment scanning device 40 to analyze the working environment of the robotic arm 10 (i.e., the area in which the robotic arm 10 can be moved), preventing the robotic arm 10 from colliding, or otherwise interfering, with other objects in the environment while being moved. As objects in the working environment may block one another from view, there are preferably a plurality of 3D environment scanning devices 40 to ensure that all the needed 3D environment parameters can be obtained. The plural 3D environment scanning devices 40 can capture environment parameters from different viewing angles respectively so as to provide the processing device 50 with enough parameters for establishing a complete 3D model.

It should be pointed out that the 3D model of the robotic arm 10 can be obtained by the processing device 50 planning with parameters sampled by the 3D environment scanning device 40 in order for the processing device 50 to carry out planning and analysis of interference in real time, as detailed further below. Preferably, the 3D model of the robotic arm 10 is obtained instead by first setting the coordinates of the robotic arm 10 and then reconstructing (i.e., simulating) the robotic arm 10 with its skeletal data and joint parameters. The latter approach can greatly reduce the load of the image processing device and enhance reliability effectively. As to the 3D model of the workpiece WP, not only can it be established by the scanning operation of the 3D object scanning device 30 (i.e., established with the 3D environment information obtained by the 3D object scanning device 30), but it also can be established with the 3D environment information obtained by the 3D environment scanning device 40; the present invention has no limitation in this regard.

The processing device 50 is coupled between the foregoing devices and works in conjunction with the storage unit 60 by accessing data in the storage unit 60 (e.g., the data in a database in the storage unit 60) and executing programs pre-stored in the storage unit 60. Please note that there may be more than one processing device 50 and more than one storage unit 60 in the present invention. If necessary, plural processing devices 50 and plural storage units 60 can work in concert with one another while executing a program to complete the intended work. In a preferred embodiment, the processing device 50 and the storage unit 60 are constructed as a single processor, such as a central processing unit (CPU), a programmable general- or special-purpose microprocessor, a digital signal processor (DSP), a programmable controller, an application-specific integrated circuit (ASIC), a programmable logic device (PLD), other similar devices, or a combination of the above.

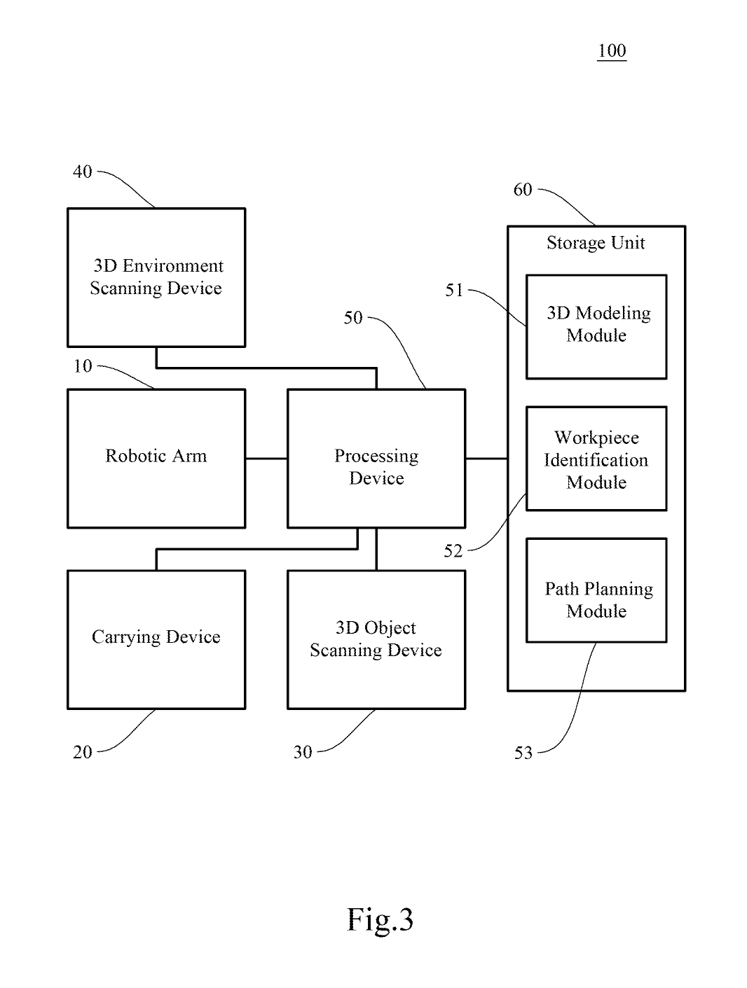

The algorithm of the present invention is described below with reference to FIG. 3, which shows a block diagram of the disclosed robotic arm processing system.

The processing device 50 includes a 3D modeling module 51, a workpiece identification module 52, and a path planning module 53 to perform its main functions respectively. The 3D modeling module 51 may be implemented as an independent graphics processing unit (GPU) to reduce the computation load of the processing device 50. Moreover, the graphics processing unit, the 3D object scanning device 30, and the 3D environment scanning device 40 may be constructed as a single unit.

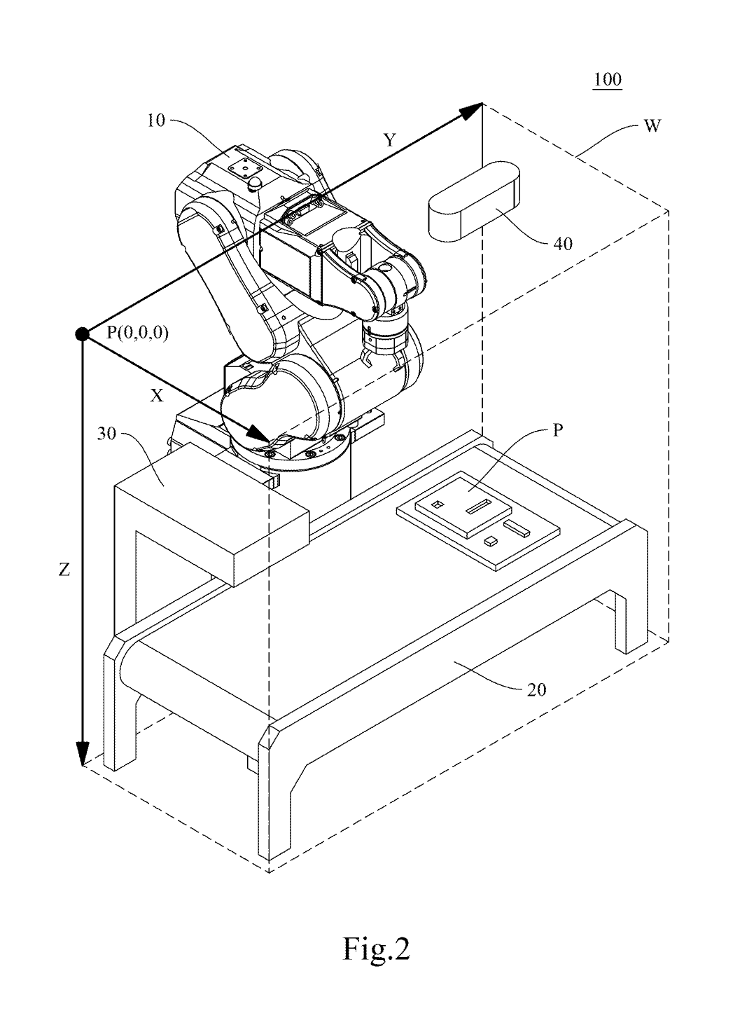

The 3D modeling module 51 is configured to establish a global coordinate system W (see FIG. 2) corresponding to the working area, to obtain the 3D model of the workpiece WP from the 3D object scanning device 30 and the 3D model of the working environment from the 3D environment scanning device 40, and to reestablish 3D spatial distribution of the entire environment based on the coordinates of each object in the environment, i.e., the workpiece WP, the robotic arm 10, and other objects in the environment (hereinafter referred to as the nearby objects).

To establish the global coordinate system W, a reference point must be set as the point of origin, from which the breadth and depth (i.e., the X-, Y-, and Z-axis dimensions) of the global coordinate system W extend. As the present invention aims to render the robotic arm 10 movable in a self-adaptive manner in its working area (i.e., the area where the robotic arm 10 is allowed to move), the relative positions of the 3D environment scanning device 40, the carrying device 20, and the robotic arm 10 are preferably fixed as early as when the machine is installed so that, when establishing the global coordinate system W, the processing device 50 can set the point of origin P(0, 0, 0) and develop the entire global coordinate system W based on the point of origin P(0, 0, 0) both rapidly and accurately.

Once the global coordinate system W is established, the 3D modeling module 51 fits three types of objects (i.e., the workpiece WP, the robotic arm 10, and the nearby objects) into the global coordinate system W according to their respective coordinates to reestablish 3D spatial distribution of the working area.

Now that the 3D object scanning device 30 has already obtained the initial 3D model of the workpiece WP by scanning, the 3D modeling module 51 can locate the workpiece WP using the coordinates of the workpiece WP in the global coordinate system W as per data sent back from the carrying device 20 and/or the 3D environment scanning device 40. More specifically, by scanning the workpiece WP, the 3D object scanning device 30 obtains the coordinates of the workpiece WP on the carrying device 20 (or a storage platform), so when the carrying device 20 moves to the working area, the coordinate relationship between the workpiece WP and the robotic arm 10 can be determined by coordinate transformation to enable planning of the position of the workpiece WP in the global coordinate system W. Here, the initial 3D model of the workpiece WP refers to a 3D model (and its coordinates, or the initial coordinates) of the workpiece WP in the initial state, i.e., before the workpiece WP is processed or manipulated.

The 3D model of the robotic arm 10 can be established using built-in skeletal parameters and coordinates together with real-time axial parameters. More specifically, the skeletal parameters and coordinates of the robotic arm 10 can be pre-stored in the storage unit 60, and a plurality of axial parameters of the robotic arm 10 can be obtained by the processing device 50 in real time in order for the processing device 50 to establish a 3D model of the robotic arm 10 using the pre-stored skeletal parameters and coordinates. Examples of axial parameters include the rotation angle θ of each joint of the robotic arm 10. Examples of skeletal parameters include the length, width, and height of each connecting rod; the length, width, and height of the base; the distance between each two adjacent joints; and the 3D model of each individual component of the robotic arm 10. The aforesaid data makes it possible to establish a real-time 3D model of the robotic arm 10 rapidly, and the resulting 3D model is a dynamic 3D model of the robotic arm 10 that can be locked onto through its preset coordinates in the global coordinate system W to prevent wasteful use of computational resources.

The 3D models of the nearby objects can be established using the 3D environment information obtained by the 3D environment scanning device 40. More specifically, the 3D environment scanning device 40 obtains the length, width, height, and position of each nearby object (e.g., an instrument, device, or other relatively static object) in the environment through a 3D scanning operation, and each nearby object thus captured is viewed as an interference-prone area, which will be taken into consideration by the path planning module 53 when planning the optimal working path.

The workpiece identification module 52 is configured to obtain the code of the workpiece WP, to identify the workpiece WP by the code, and to obtain the corresponding assembly procedure according to the code. Preferably, the code of the workpiece WP is obtained through a barcode reader provided on one side of the carrying device 20. More specifically, the database in the storage unit 60 can be used to store a corresponding lookup table indexed by workpiece code (or workpiece shape), and after identifying the code of the workpiece WP, the processing device 50 obtains the corresponding assembly procedure in the lookup table according to the code obtained. For example, after identifying a circuit board code N01, a capacitor code N02, and a single-chip code N03, the processing device 50 can find the corresponding index entries according to the code combination N01, N02, N03 and then obtain the corresponding assembly procedures (e.g., mounting the capacitor N02 at a position A on the circuit board N01, and mounting the single chip N03 at a position B on the circuit board N01) through the index entries. In another preferred embodiment, the code of the workpiece WP is obtained by the processing device 50 comparing the initial 3D model of the workpiece WP against a category in the database.

The path planning module 53 is configured to exclude the interference-prone areas between the robotic arm 10 and the nearby objects according to the established 3D models and then plan the optimal working path in the global coordinate system W so that the robotic arm 10 can be driven along the optimal working path to perform on the workpiece WP the assembly procedure found in the lookup table. More specifically, once the procedure to be performed is known, the path planning module 53 plans the optimal path combination according to the procedure. If there are plural robotic arms 10, interference between the robotic arms 10 must also be taken into account. The algorithm by which to determine the optimal path is as follows. Step 1: set the 3D models of the nearby objects as interference-prone areas, and eliminate unviable paths. Step 2: analyze the feasible path(s) of the robotic arm 10, and in cases where there are multiple feasible paths, choose the optimal one, which may be a path with the smallest joint movements or a path with the shortest point-to-point distance in the global coordinate system W, the present invention imposing no limitation in this regard. The foregoing steps enable the robotic arm 10 to analyze the working environment in a self-adaptive manner so as to complete the intended assembly procedures in different working environments.

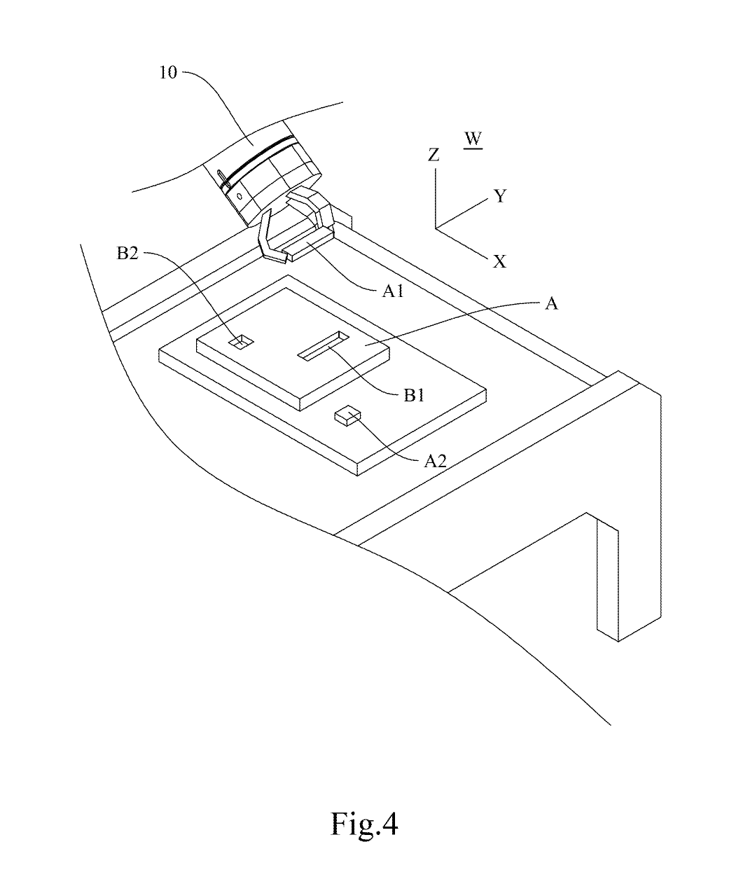

A number of application examples of the present invention are described below. To begin with, please refer to FIG. 4 for a state of use of the disclosed robotic arm processing system in a first application example.

In this application example, the robotic arm processing system 100 is applied to the assembly of a circuit board A. The circuit board A and its components A1 and A2 (the three of which are hereinafter generally referred to as workpieces) are scanned by the 3D object scanning device 30 to produce their respective 3D models. The model numbers of the workpieces are obtained through a barcode reader or by comparing the 3D models of the workpieces against a category in the database. Once the model numbers of the workpieces are known, the processing device 50 obtains the corresponding assembly procedures in a lookup table, plans the optimal paths according to the assembly procedures, and then carries out the assembly.

While analyzing the procedures, the processing device 50 divides the circuit board A into target zones B1 and B2 based on the global coordinate system W, in order to mount the components A1 and A2 sequentially in the target zones B1 and B2 of the circuit board A according to the predetermined order and orientations, thereby completing the assembly process.

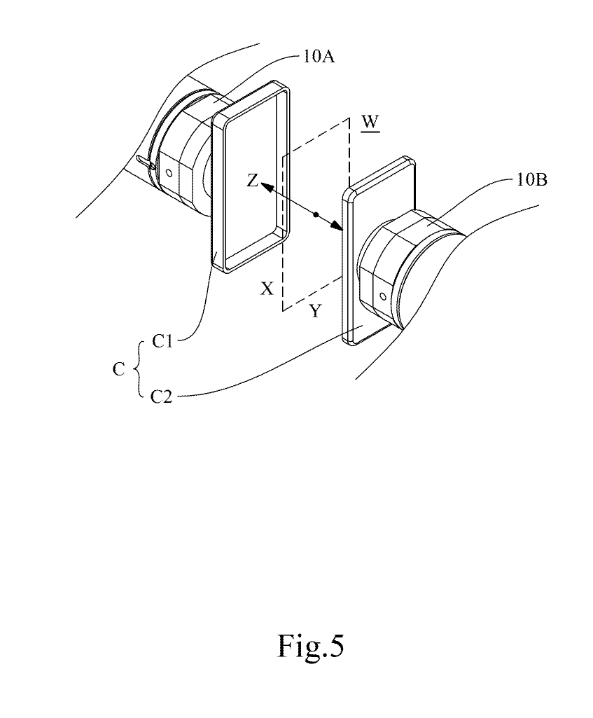

FIG. 5 shows a state of use of the disclosed robotic arm processing system in a second application example.

In this application example, the robotic arm processing system 100 is applied to the assembly of a mobile device case C and uses two robotic arms 10A and 10B (or one robotic arm and a jig) to complete the assembly. The first case component C1 and the second case component C2 of the mobile device case C (hereinafter generally referred to as workpieces) are respectively scanned by the 3D object scanning device 30 to produce their respective 3D models, and the model numbers of the workpieces are subsequently obtained. After that, the processing device 50 analyzes the positions of the workpieces in the global coordinate system W.

Once the positions of the first case component C1 and of the second case component C2 in the global coordinate system W are determined, the two robotic arms 10A and 10B move to and grip the first case component C1 and the second case component C2 according to the planed optimal paths respectively. The position of one of the robotic arms (say, 10A) is then fixed and serves as a reference point, meaning the position of the first case component C1 in the global coordinate system W is fixed. In the meantime, the other robotic arm 10B, which is holding the second case component C2, adjusts the position of the second case component C2 in the global coordinate system W so that the X- and Y-axis coordinates of the second case component C2 correspond to, or are identical to, those of the first case component C1. The robotic arm 10B then moves the second case component C2 in the Z-axis direction to connect the second case component C2 to the first case component C1.

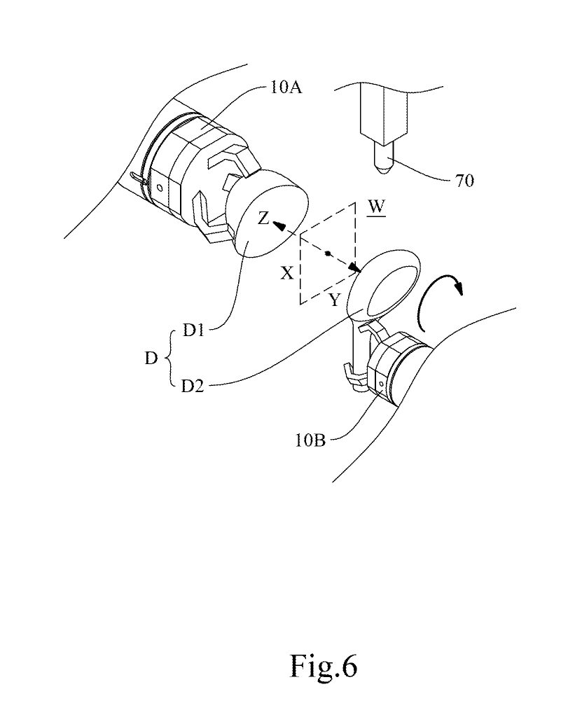

FIG. 6 shows a state of use of the disclosed robotic arm processing system in a third application example.

In this application example, the robotic arm processing system 100 is applied to the assembly of a golf club head D and uses two robotic arms 10A and 10B (or one robotic arm and a jig, as in the second application example) and an adhesive-dispensing device 70 to complete the assembly. The first component D1 and the second component D2 of the club head D are respectively scanned by the 3D object scanning device 30 to produce their respective 3D models, and the model number of the club head D is subsequently obtained. After that, the processing device 50 analyzes the positions of the first component D1 and of the second component D2 in the global coordinate system W.

Once the positions of the first component D1 and of the second component D2 in the global coordinate system W are determined, the two robotic arms 10A and 10B grip the first component D1 and the second component D2 respectively. The position of one of the robotic arms (say, 10A) is then fixed and serves as a reference point, meaning the position of the first component D1 in the global coordinate system W is fixed. In the meantime, the other robotic arm 10B, which is holding the second component D2, adjusts the position of the second component D2 in the global coordinate system W so that the X- and Y-axis coordinates of the second component D2 correspond to those of the first component D1. The robotic arm 10A or 10B then moves in the Z-axis direction to put the first component D1 and the second component D2 together at the right angle. In a preferred embodiment, the rotation axis of the robotic arm 10A corresponds in position to that of the robotic arm 10B, so the two robotic arms 10A and 10B can rotate the club head D in an XY plane while moving the gap between the first component D1 and the second component D2 along the Z axis into alignment with the adhesive outlet of the adhesive-dispensing device 70 to complete the processing procedure.

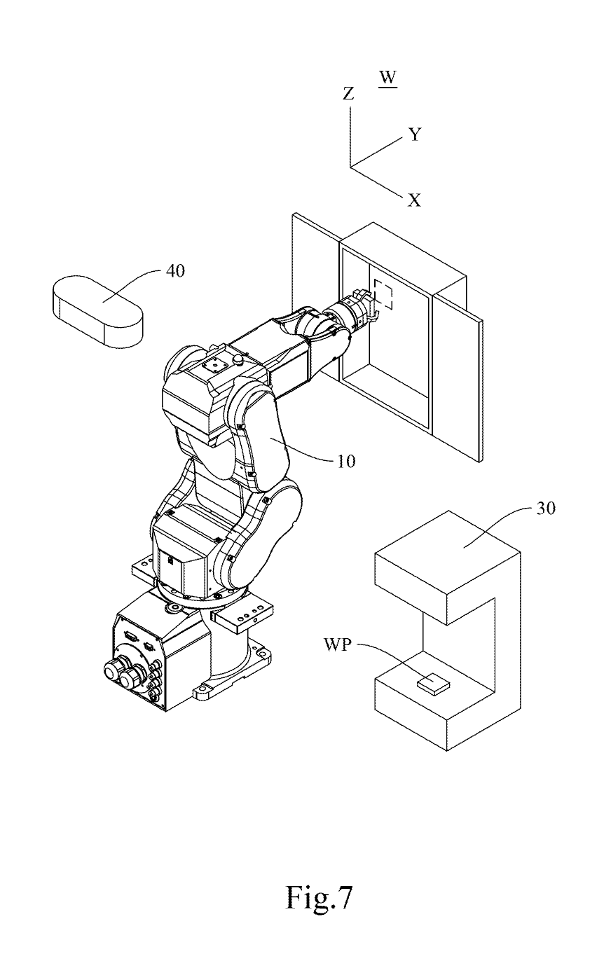

FIG. 7 shows a state of use of the disclosed robotic arm processing system in a fourth application example.

In this application example, the robotic arm processing system 100 is applied to the assembly of a piece of equipment in a complicated environment. More specifically, the robotic arm 10 and the 3D environment scanning device 40 are movably arranged in an assembly area. Before assembly, the 3D environment scanning device 40 scans the working area to generate a 3D model of the working environment, and the 3D object scanning device 30 scans the to-be-handled workpiece WP to generate a 3D model of the workpiece WP. Once the 3D model of the environment is obtained, the robotic arm 10 searches for the to-be-handled object and the corresponding assembly procedure according to a preset program, plans the optimal path according to the assembly procedure, and then carries out the assembly.

This example illustrates potential use of the present invention in a highly dangerous and/or complicated environment (e.g., to assemble a distribution board or a piece of industrial equipment), in which the robotic arm 10 can judge of its own accord to avoid intervention-prone areas in the environment in order to complete the intended assembly process.

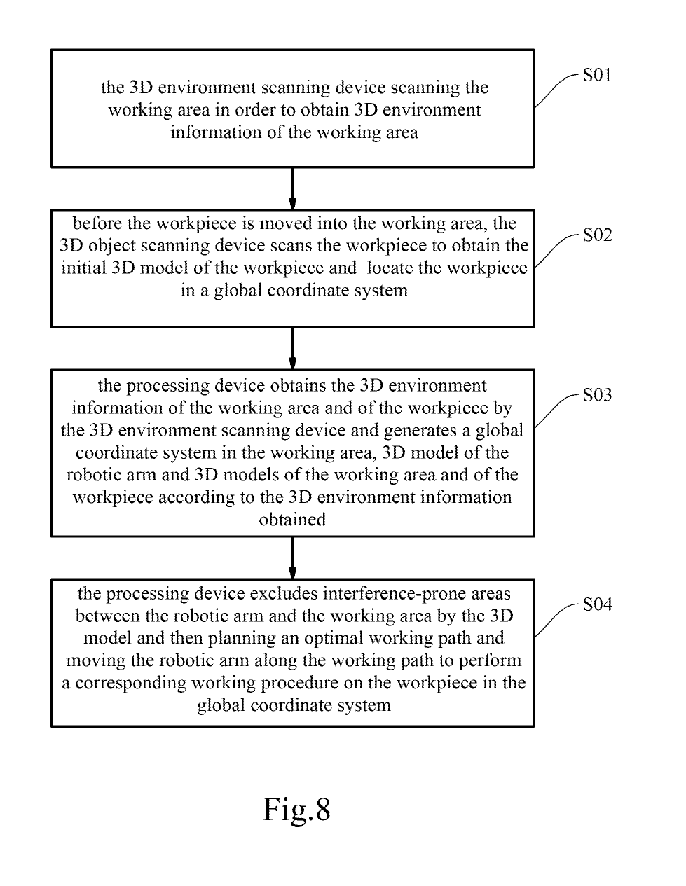

A detailed description of the disclosed robotic arm processing method is given below with reference to FIG. 8, which shows the flowchart of the method.

The robotic arm processing method begins with the 3D environment scanning device 40 scanning the working area in order to obtain 3D environment information of the working area (step S01).

Then, before the workpiece WP is moved into the working area, the 3D object scanning device 30 scans the workpiece WP to obtain 3D environment information of the workpiece WP (step S02). Please note that step S01 and step S02 may be switched in order, and that the environment, including the working area, may be scanned before each robotic-arm operation. In another preferred embodiment, the 3D environment information of the workpiece WP is obtained through the 3D environment scanning device 40.

Following that, the processing device 50 obtains the 3D environment information of the working area and of the workpiece WP and generates 3D models of the working area and of the workpiece according to the 3D environment information obtained (step S03).

Based on the 3D model of the working area and the 3D model of the workpiece WP, the processing device 50 generates a working path along which the robotic arm 10 will be driven to perform the corresponding procedure on the workpiece WP (step S04). More specifically, the processing device 50 begins by excluding the interference-prone areas between the robotic arm 10 and the environment according to the 3D models and then plans the optimal working path in the global coordinate system W by obtaining the code of the workpiece WP, obtaining the corresponding assembly procedure in a lookup table, and planning the working path according to the assembly procedure.

The present invention further provides a non-transitory computer-readable storage medium that stores a computer program for performing the steps of the disclosed robotic arm processing method.

As above, the present invention renders a robotic arm self-adaptive and thereby enables the robotic arm to find the optimal working paths in non-single manufacturing processes of customized products. Moreover, the invention can be used in a non-normal working environment, allowing a relatively good working path to be obtained by detecting changes in the working environment in real time and replanning the working path according to the changed working environment.

While the present invention has been described in connection with certain exemplary embodiments, it is to be understood that the invention is not limited to the disclosed embodiments, but, on the contrary, intended to cover various modifications and equivalent arrangements included within the spirit and scope of the appended claims and equivalents thereof.

What is claimed is:

1. A robotic arm processing system, comprising:
at least one robotic arm for performing a processing procedure on at least one workpiece in a working area;
at least one three-dimensional (3D) environment scanning device for scanning the working area to obtain 3D environment information of the working area; and
a processing device coupled between the robotic arm and the 3D environment scanning device and configured for generating a 3D model of the workpiece and a 3D model of the working area according to 3D environment information of the workpiece and the 3D environment information of the working area;
wherein the processing device generates a working path according to the 3D model of the workpiece and the 3D model of the working area and drives the robotic arm along the working path to perform a corresponding working procedure on the workpiece.

2. The robotic arm processing system of claim 1, wherein the processing device comprises:
a 3D modeling module for generating the 3D model of the workpiece and the 3D model of the working area according to the 3D environment information of the workpiece and the 3D environment information of the working area;
a workpiece identification module for identifying the workpiece and obtaining the corresponding working procedure of the workpiece according; and
a path planning module for planning an optimal working path through excluding interference-prone areas between the robotic arm and the working area.

3. The robotic arm processing system of claim 1, wherein skeletal parameters and coordinates of the robotic arm are stored in a storage unit in advance, and the processing device obtains a plurality of axial parameters of the robotic arm in real time in order to generate a 3D model of the robotic arm according to the skeletal parameters and the coordinates of the robotic arm.

4. The robotic arm processing system of claim 1, wherein before the workpiece enters the working area, a 3D object scanning device generates the 3D model of the workpiece by scanning the workpiece and transmits the 3D model of the workpiece to the processing device; wherein the processing device locates the workpiece on a global coordinate system through at least one sensor.

5. The robotic arm processing system of claim 2, wherein after identifying a plurality of codes of the workpiece, the processing device obtains a corresponding assembly procedure in a lookup table according to the plurality of codes and plans the optimal working path according to the assembly procedure.

6. The robotic arm processing system of claim 5, wherein the code of the workpiece is obtained through a barcode reader provided on one side of a carrying device.

7. The robotic arm processing system of claim 5, wherein the code of the workpiece is obtained by the processing device comparing the 3D model of the workpiece against a category in a database.

8. A robotic arm processing method, comprising the steps of:
scanning a working area of a robotic arm in order to obtain three-dimensional (3D) environment information of the working area;
generating a 3D model of a workpiece and a 3D model of the working area according to 3D environment information of the workpiece and the 3D environment information of the working area; and
generating a working path according to the 3D model of the workpiece and the 3D model of the working area, and driving the robotic arm along the working path to perform a corresponding working procedure on the workpiece.

9. The robotic arm processing method of claim 8, further comprising the steps of:
identifying the workpiece through a code of the workpiece;
obtaining a corresponding assembly procedure in a lookup table according to the codes obtained and planning the working path according to the corresponding assembly procedure.

10. The robotic arm processing method of claim 8, wherein before the workpiece enters the working area, scanning the workpiece in order to generate the 3D model of the workpiece and locates the workpiece in a global coordinate system continuously.

11. A non-transitory computer-readable storage medium comprising a computer program to be accessed by a device in order to perform the robotic arm processing method of claim 8.
